(19) United States
(12) Patent Application Publication
(10) Pub. No.: US 2008/0298880 A1
(43) Pub. Date: Dec. 4, 2008

(54) Page Turning Assist Device with a Holder

(75) Inventor: Chun Yuen To, Hong Kong (CN)

Correspondence Address: SENNIGER POWERS LLP, 100 NORTH BROADWAY, 17TH FLOOR, ST LOUIS, MO, 63102, US

(73) Assignee: WORLD WIDE STATIONERY MFG. CO., LTD., Hong Kong (CN)

(21) Appl. No.: 11/754,553

(22) Filed: May 29, 2007

(51) Int. Cl. B42F 3/04

(52) U.S. Cl. 402/4

(57) ABSTRACT

A page turning assist device for use in turning loose leaf pages retained on rings of a ring mechanism includes a base having opposite side margins and being more rigid than the loose leaf pages. At least one aperture in one of the side margins of the base is sized and shaped for receiving a corresponding one of the rings therethrough to permit the base to slide along the ring for use in turning the loose leaf pages on the ring mechanism. A holder is mounted on the base for generally conjoint movement with the base on the ring. The holder is adapted for releasably securing an object to the base for movement with the base.

### FIELD OF THE INVENTION

This invention relates to notebooks for retaining loose-leaf pages, and in particular to a notebook having a page turning assist device with a holder mounted thereon for holding objects in the notebook.

### BACKGROUND

Conventional notebooks include a cover and a ring binder mechanism mounted on the cover for retaining loose-leaf pages. Ring members of the ring binder mechanism can be selectively opened to add or remove pages or closed to retain pages while allowing the pages to be moved along the ring members. While conventional notebooks are well suited for holding loose-leaf pages, they are typically not suited for holding implements (e.g., pens or pencils) for writing on the loose-leaf pages. In instances where they do hold pens, pencils, and the like, the location is remote from the place where they are needed (i.e., the current loose leaf page).

### SUMMARY OF THE INVENTION

A notebook for holding loose-leaf pages generally comprises a cover having a front, a back, and a spine. The front and back are hingedly attached to the spine for movement to selectively cover and expose loose-leaf pages held by the notebook. A ring binder mechanism mounted on the cover generally comprises a housing, a ring mount supported by the housing for movement relative to the housing, and rings for holding the loose-leaf pages. Each ring includes a first ring member and a second ring member. The first ring member is operatively connected to the ring mount for movement relative to the second ring member between a closed position and an opened position of the ring members. In the closed position, the two ring members form a substantially continuous, closed loop for allowing loose-leaf pages retained by the rings to be moved along the rings from one ring member to the other. In the opened position, the two ring members form a discontinuous, open loop for adding or removing loose-leaf pages from the rings. A page turning assist device more rigid than the loose leaf pages is adapted to be captured by the rings for movement along the rings from one ring member to another ring member for use in turning loose leaf pages retained by the rings. A holder is mounted on the page turning assist device and is adapted to releasably hold an object for movement with the page turning assist device.

A page turning assist device for use in turning loose leaf pages retained on rings of a ring mechanism generally comprises a base having opposite side margins and being more rigid than the loose leaf pages. At least one aperture in one of the side margins of the base is sized and shaped for receiving a corresponding one of the rings therethrough to permit the base to slide along the ring for use in turning the loose leaf pages on the ring mechanism. A holder is mounted on the base for generally conjoint movement with the base on the ring. The holder is adapted for releasably securing an object to the base for movement with the base.

Other features of the invention will be in part apparent and in part pointed out hereinafter.

### BRIEF DESCRIPTION OF THE DRAWINGS

FIG. 1 is a perspective of a notebook for holding loose-leaf pages;

FIG. 2 is a perspective similar to FIG. 1 but illustrating a pen being held by a holder mounted on a page turning assist device;

FIG. 3 is a perspective of the page turning assist device and holder removed from the notebook;

FIG. 4 is an end elevation of the page turning assist device and holder of FIG. 3;

FIG. 5 is an end elevation similar to FIG. 4 but illustrating the pen being held by the holder;

FIG. 6 is an exploded perspective of the page turning assist device and holder;

FIG. 7 is a top side perspective of a ring mechanism removed from the notebook, rings of the mechanism being in a closed position; and

FIG. 8 is a bottom side perspective of the ring mechanism of FIG. 7 with the rings being in an opened position.

Corresponding reference numbers indicate corresponding parts throughout the views of the drawings.

### DETAILED DESCRIPTION

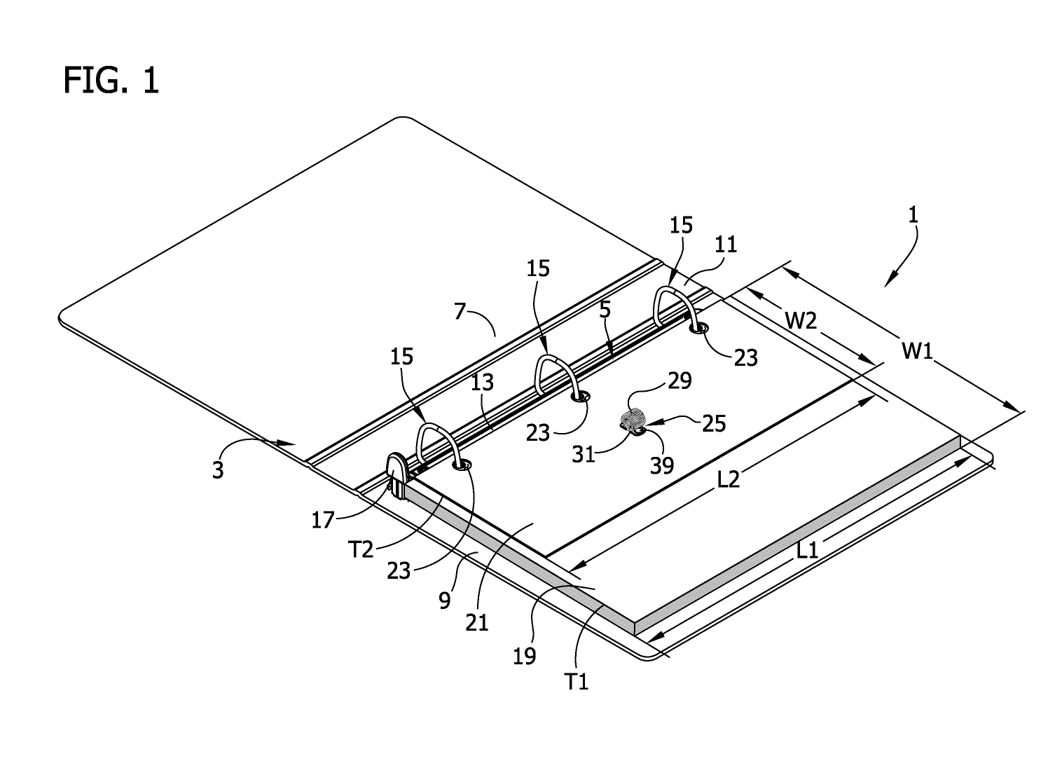

Referring now to the drawings, FIG. 1 illustrates a notebook, indicated generally at 1, comprising a cover, designated generally at 3, and a ring binder mechanism, designated generally at 5, mounted on the cover. The cover 3 includes a front 7, a back 9, and a spine 11. The front 7 and back 9 are hingedly attached to the spine 11. The ring binder mechanism 5 comprises a housing 13, three rings (each designated generally at 15) supported by the housing, and a lever 17 (also broadly referred to as an “actuator”) mounted adjacent an end of the housing. The rings 15 retain loose-leaf pages 19 on the ring binder mechanism 5 in the notebook 1 while the lever 17 operates to open and close the rings so that pages can be added or removed. The front 7 of the cover 3 moves relative to the ring binder mechanism 5 to selectively cover or expose loose-leaf pages 19 retained by the ring binder mechanism in the notebook 1. Each of the loose-leaf pages 19 has a width W1, a length L1, and a thickness T1. Ring binder mechanisms mounted on notebooks in other ways or on surfaces other than a notebook, for example, a file, do not depart from the scope of this invention. Moreover, a notebook may have other configurations than the one shown and described herein without departing from the scope of the present invention.

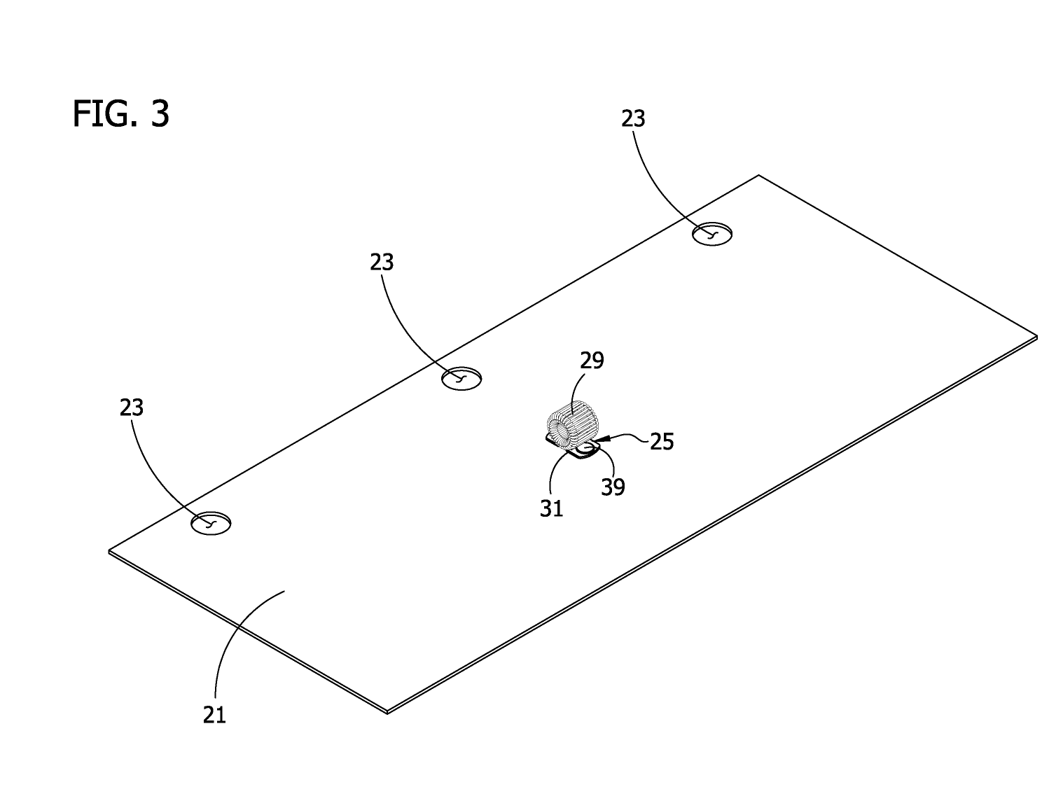

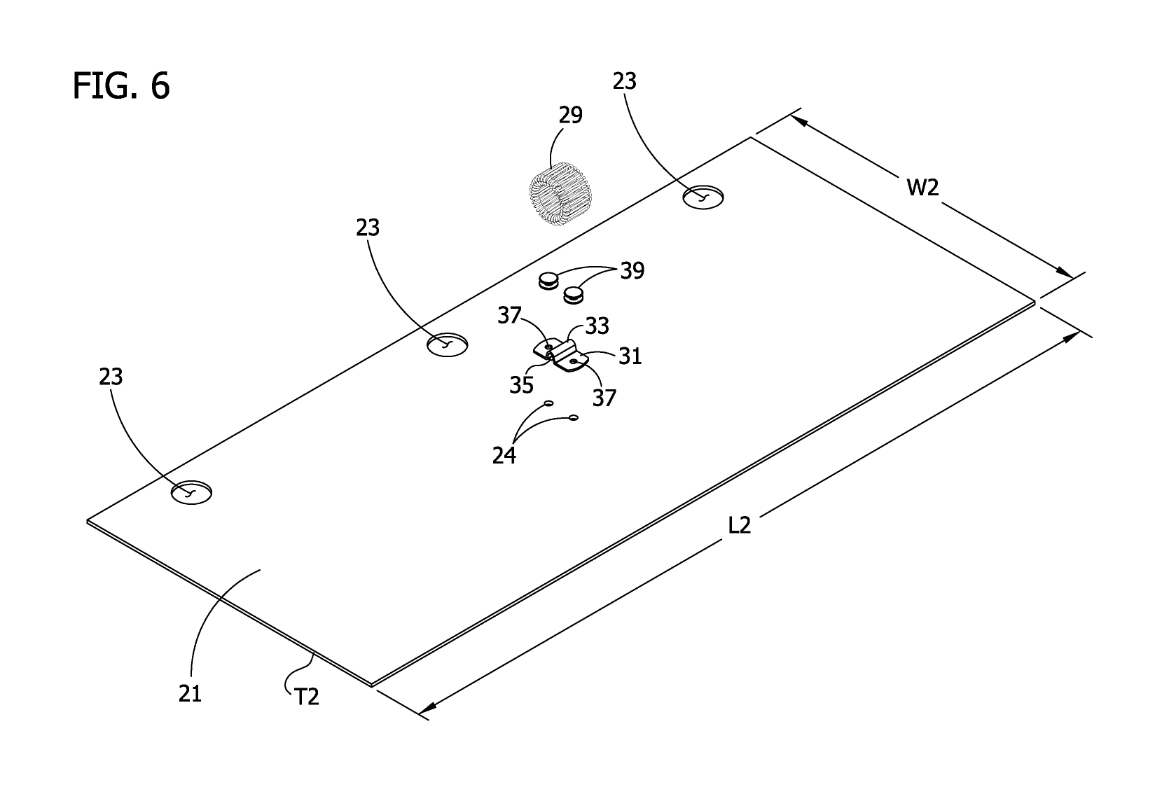

The notebook 1 also comprises a page turning assist device 21 held by the rings 15 of the ring binder mechanism 5 for movement along the rings. More specifically, the page turning assist device 21 includes apertures 23 for allowing the rings 15 to pass therethrough. As illustrated in FIG. 1, the diameters of the apertures 23 are larger than the diameters of the rings 15 which facilitate easy manual movement of page turning assist device 21 along the rings. As illustrated in FIG. 6, the page turning assist device 21 also includes a pair of spaced apart openings 24 disposed near the center of the page turning assist device. The page turning assist device 21, which is generally rectangular, has a width W2, a length L2, and a thickness T2 (FIGS. 1 and 6). The width W2 and length L2 of the page turning assist device 21 are less than the width W1 and length L1, respectively, of the loose-leaf pages 19. The thickness T2 of the page turning assist device 21, however, is greater than the thickness T1 of the loose-leaf pages 19. It is understood that the page turning assist device can have shapes and sizes different than those provided herein and illustrated in the accompanying drawings. The page turning assist device 21 illustrated in FIGS. 1-6 is formed from cardboard but it is understood that the page turning assist device can be formed from other suitable materials (e.g., plastic) without departing from the scope of this invention.

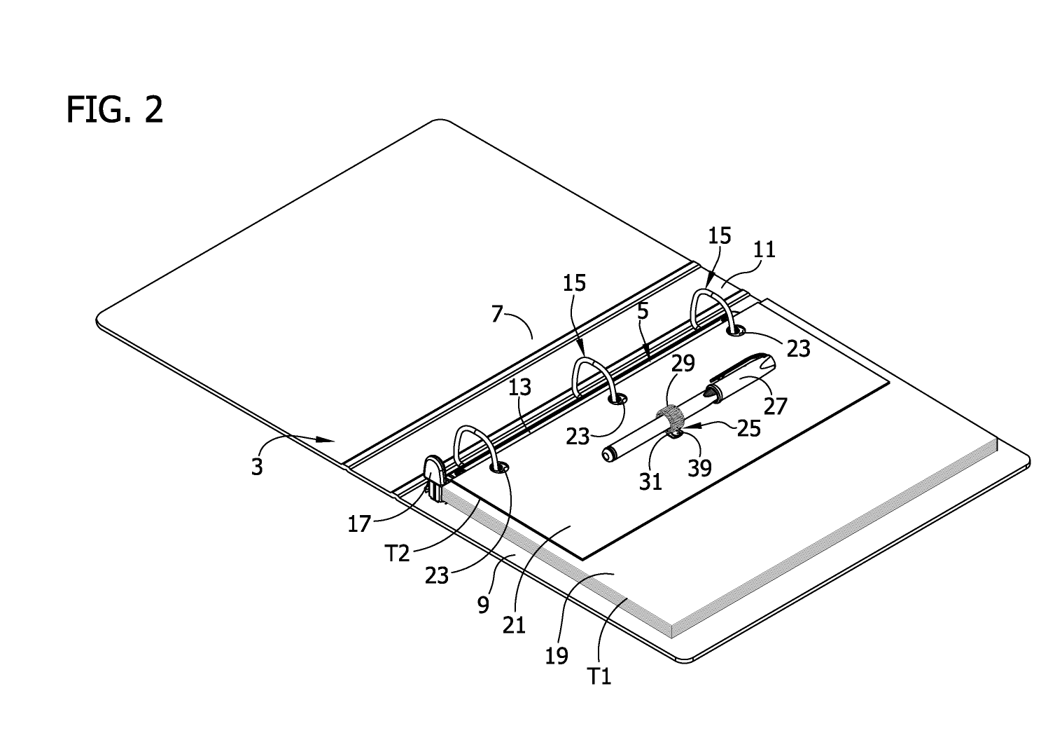

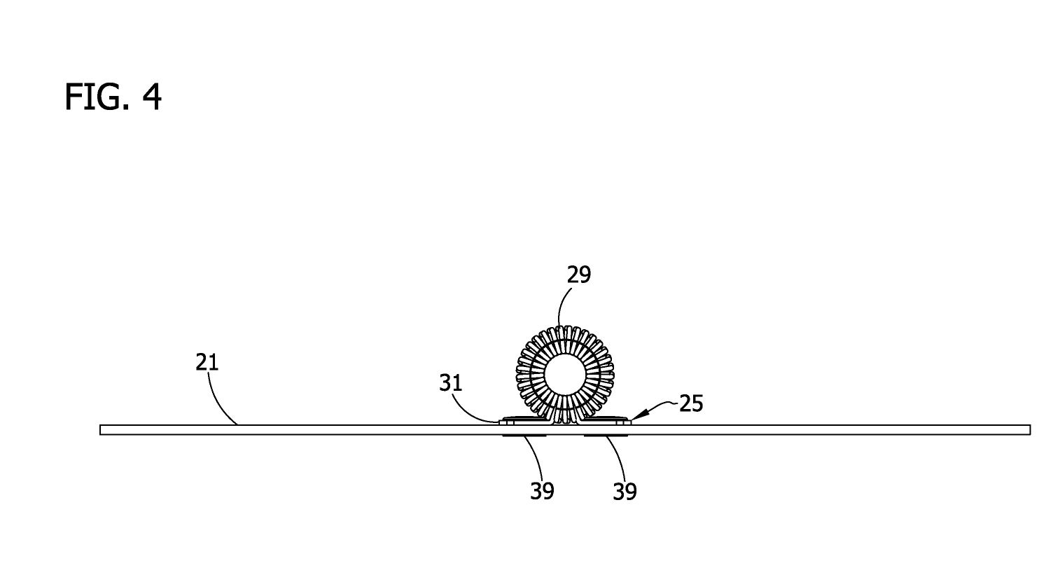

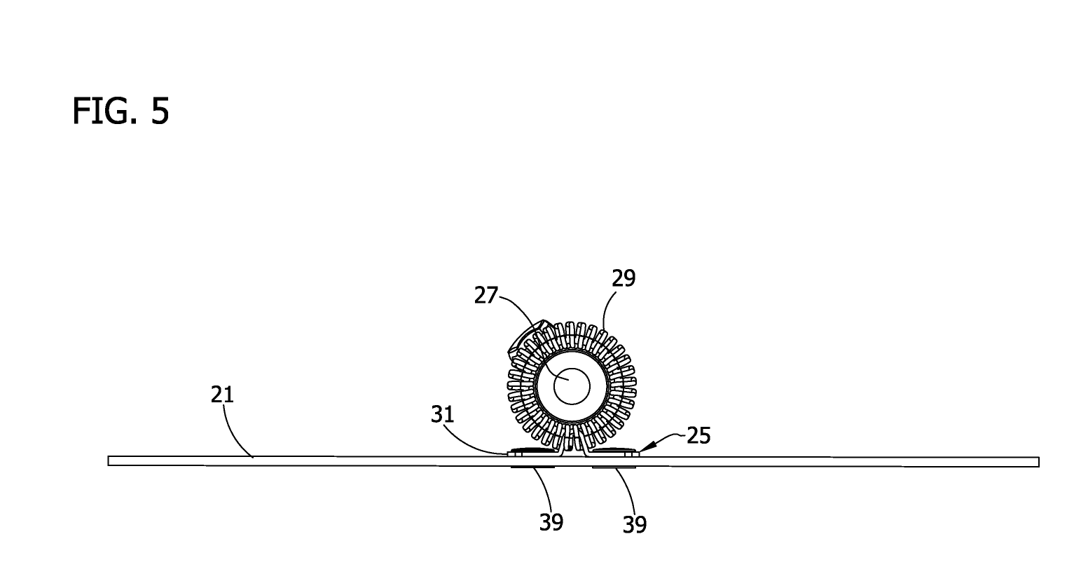

The notebook 1 further comprises a holder, designated generally at 25, mounted on the page turning assist device 21 and adapted to hold an object. Particularly, the holder 25 is sized and shaped for releasably holding a writing implement (e.g., a pencil or a pen 27 as is illustrated in FIGS. 2 and 5). The holder 25 is expandable for holding writing implements of various sizes. In the illustrated configuration, the holder 25 is adapted for holding writing implement (e.g., pen 27) with cross-sectional diameters between about 6.5 mm and about 16 mm. More specifically, the holder 25, which is generally cylindrical, comprises an accordion folded wire 29 that is resiliently expandable in diameter between a more folded condition (FIGS. 1 and 4) and an expanded, more unfolded condition for holding the writing implements (FIGS. 2 and 5). The resiliency of the holder 25 allows it to bear against and grip the pen 27 when held by the holder. Other, non-resilient constructions of a holder may be used within the scope of the present invention. Moreover, a resilient holder may be formed out of other than folded wire.

The holder 25 further comprises a bracket 31 mounted on the page turning assist device 21 for securing the folded wire 29 to the page turning assist device. With reference to FIG. 6, the bracket 31 includes a peak 33 defining a channel 35 for capturing a portion of the folded wire 29. Two holes 37 are provided in the bracket 31 for aligning with the openings 24 in the page turning assist device 21. Fasteners (e.g., rivets 39) are inserted through the holes 37 in the bracket 31 and the openings 24 in the page turning assist device 21 to mount the holder 25 on the page turning assist device. In the illustrated configuration, the holder is seen mounted generally in the center of the page turning assist device but it is understood that the holder can be mounted in different locations on the page turning assist device (including on an opposite side of the page turning assist device). It is also understood that more than one holder can be mounted on the page turning assist device so that more than one writing implement can be held in the notebook.

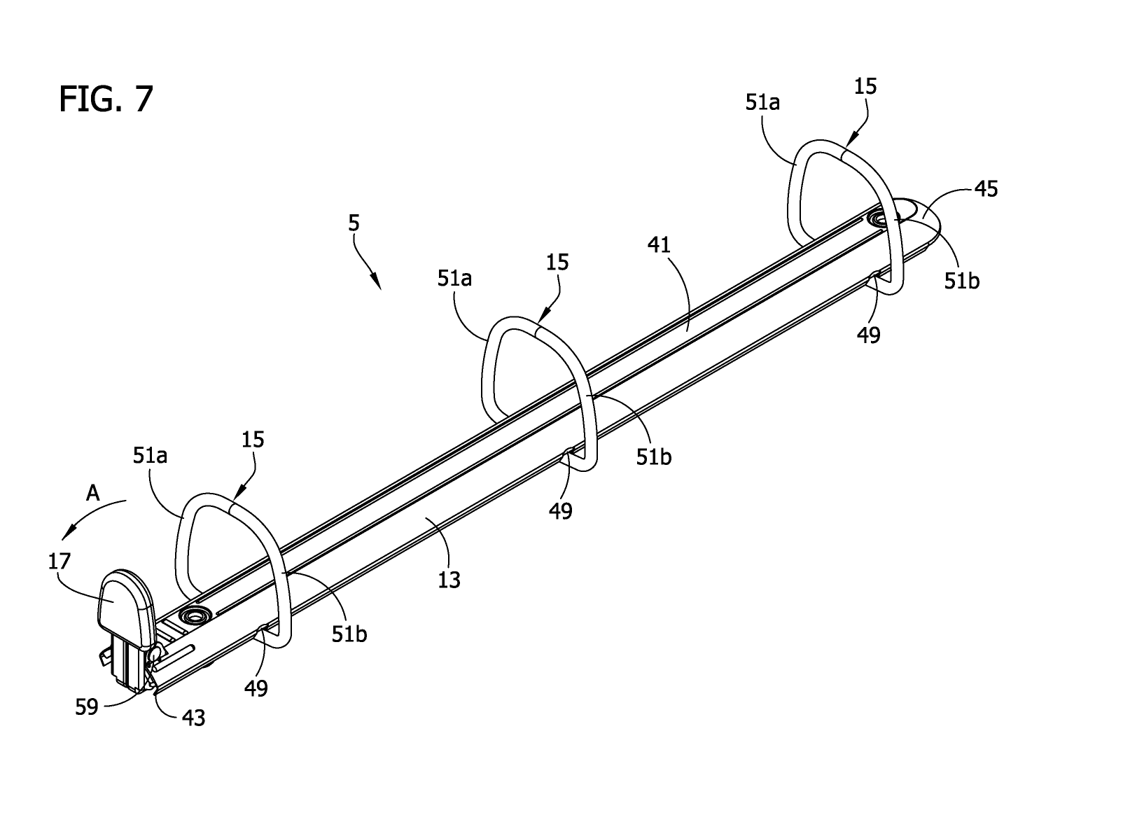

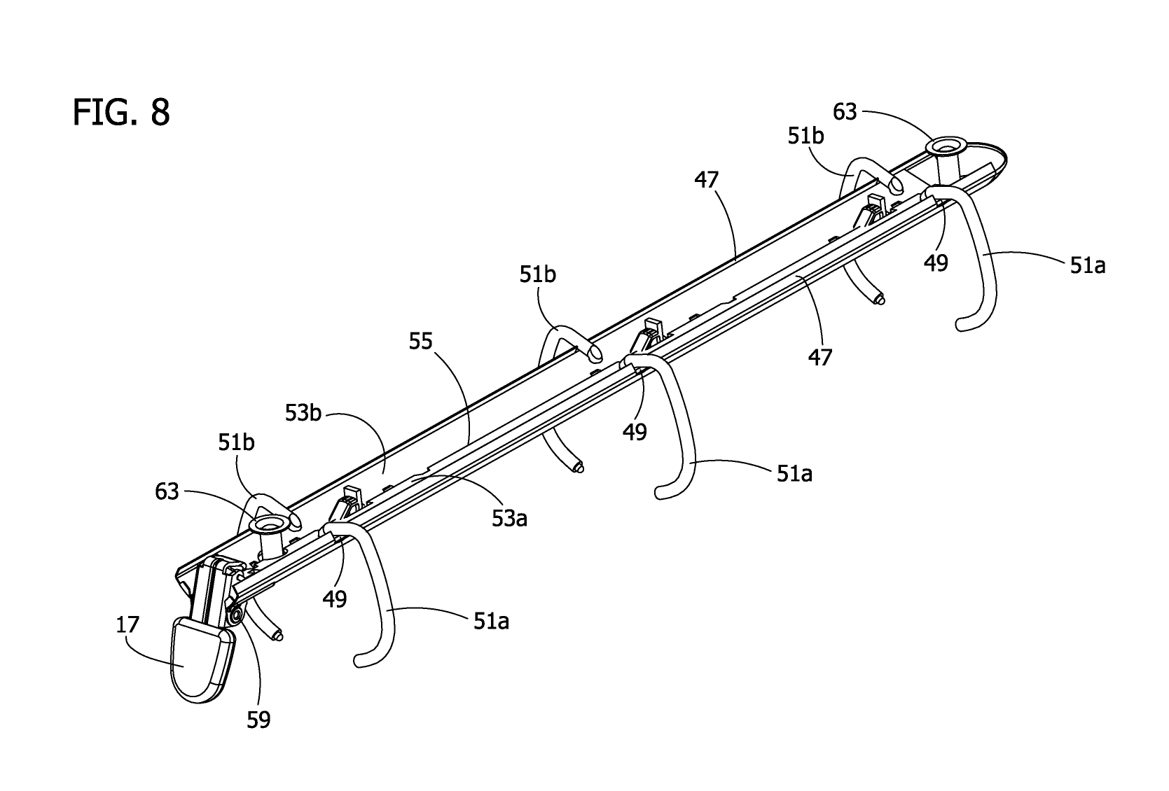

With reference to FIGS. 7 and 8, the housing 13 of the ring binder mechanism 5 is shaped as an elongate rectangle with a uniform, roughly arch-shaped cross section, having at its center a generally flat plateau 41. A first longitudinal end 43 of the housing 13 (to the left in FIG. 7) is generally open while a second, opposite longitudinal end 45 is generally closed (to the right in FIG. 7). As seen in FIG. 8, bent under rims 47 extend lengthwise along longitudinal edges of the housing 13 from its first longitudinal end 43 to its second longitudinal end 45. Each of the bent under rims 47 includes three spaced-apart cutouts 49. Mechanisms having housings of other shapes, including irregular shapes, or housings that are integral with a file or notebook do not depart from the scope of this invention.

The three rings 15 of the ring binder mechanism 5 are substantially similar and are each generally circular in shape (e.g., FIG. 7). Each of the rings has two generally semi-circular ring members 51a, 51b formed from a conventional, cylindrical rod of a suitable material (e.g., steel). The rings 15 could be D-shaped as is known in the art, or otherwise shaped within the scope of this invention. Ring binder mechanisms with ring members formed of different material or having different cross-sectional shapes, for example, oval shapes, or different free end configurations do not depart from the scope of this invention.

As illustrated in FIG. 8, the ring binder mechanism 5 includes two substantially identical hinge plates (together broadly defining a “ring mount”), designated generally at 53a, 53b, supporting the ring members 51a, 51b, respectively. The hinge plates 53a, 53b are each generally elongate, flat, and rectangular in shape and are each somewhat shorter in length than the housing 13. The hinge plates 53a, 53b are interconnected in parallel arrangement along their inner longitudinal edge margins, forming a central hinge 55 having a pivot axis. This is done in a conventional manner known in the art. As will be described, the hinge plates 53a, 53b can pivot about the hinge 55 upward and downward.

The housing 13 supports the interconnected hinge plates 53a, 53b within the housing. The outer longitudinal edge margins of the hinge plates 53a, 53b loosely fit behind the bent under rims 47 of the housing 13 for allowing them to move within the rims when the hinge plates pivot. The ring members 51a, 51b extend through respective cutouts 49 along sides of the housing 13 so that the ring members can engage above the housing. The ring members 51a, 51b are rigidly connected to respective ones of the hinge plates 53a, 53b as is known in the art and move with the hinge plates when they pivot. Although in the illustrated ring binder mechanism 5 both ring members 51a, 51b of each ring 15 are each mounted on one of the two hinge plates 53a, 53b and move with the pivoting movement of the hinge plates, a mechanism in which each ring has one movable ring member and one fixed ring member does not depart from the scope of this invention (e.g., a mechanism in which only one of the ring members of each ring is mounted on a hinge plate with the other ring member mounted, for example, on a housing).

As is known, the hinge plates 53a, 53b pivot downward and upward relative to the housing 13 and move the ring members 51a, 51b mounted thereon between a closed position (FIG. 7) and an opened position (FIG. 8). The hinge plates 53a, 53b are wider than the housing 13 when in a co-planar position (180°), so as they pivot through the co-planar position, they deform the housing and create a spring force in the housing. The housing spring force biases the hinge plates 53a, 53b to pivot away from the co-planar position, either downward or upward. The ring members 51a, 51b close when the hinge plates 53a, 53b pivot downward (i.e., the hinge 55 moves away from the housing 13 (FIG. 7)). The ring members 51a, 51b open when the hinge plates 53a, 53b pivot upward (i.e., the hinge 55 moves toward the housing 13 (FIG. 8)).

Referring still to FIGS. 7 and 8, the lever 17 is pivotally mounted on the housing 13 adjacent the first longitudinal end 43 thereof via a hinge pin 59. Pivoting movement of the lever 17 in a counter-clockwise direction as indicated by the arrow A in FIG. 7 causes the lever to contact and conjointly pivot the interconnected hinge plates 53a, 53b upward. Once the hinge plates 53a, 53b pass through the co-planar position, the housing spring force pushes them upward, opening the ring members 51a, 51b. To close the ring members 51a, 51b, an operator can pivot the lever 17 from the position illustrated in FIG. 8 upward and inward (i.e., clockwise in FIG. 7) back to the position illustrated in FIG. 7. During pivoting of the lever 17, the lever contacts and pushes downward on the upper surfaces of the hinge plates 53a, 53b, but the spring force of the housing 13 resists the initial hinge plate movement. As the lever 17 continues to pivot, the lever 17 causes the interconnected hinge plates 53a, 53b to pivot downward. Once the hinge plates 53a, 53b pass through the co-planar position, the housing 13 spring force pushes them downward, closing the ring members 51a, 51b. In the illustrated configuration, the ring members 51a, 51b can also be closed by manually pushing the ring members together. An actuator (not shown) may take other forms than the lever 17. Further, there may be more than one lever.

With reference to FIG. 8, two mounting posts 63 are secured to the illustrated ring binder mechanism 5 to mount the mechanism on the cover 3 (e.g., FIG. 1) in any suitable manner. The posts 63 are attached to the plateau 41 of the housing 13 toward the longitudinal ends 43, 45 of the housing. It is understood that the ring binder mechanism can be secured to the cover in different ways.

Components of ring binder mechanisms of the embodiments described and illustrated herein are made of a suitable rigid material, such as a metal (e.g. steel). But mechanisms having components made of a nonmetallic material, specifically including a plastic, do not depart from the scope of this invention.

When introducing elements of the ring binder mechanisms herein, the articles “a”, “an”, “the” and “said” are intended to mean that there are one or more of the elements. The terms “comprising”, “including” and “having” and variations thereof are intended to be inclusive and mean that there may be additional elements other than the listed elements. Moreover, the use of “forward” and “rearward” and variations of these terms, or the use of other directional and orientation terms, is made for convenience, but does not require any particular orientation of the components.

As various changes could be made in the above without departing from the scope of the invention, it is intended that all matter contained in the above description and illustrated in the accompanying drawings shall be interpreted as illustrative and not in a limiting sense.

What is claimed is:

1. A notebook for holding loose-leaf pages, the notebook comprising:
a cover having a front, a back, and a spine, the front and back being hingedly attached to the spine for movement to selectively cover and expose loose-leaf pages held by the notebook;
a ring binder mechanism mounted on the cover, the ring binder mechanism comprising:
a housing;
a ring mount supported by the housing for movement relative to the housing;
rings for holding the loose-leaf pages, each ring including a first ring member and a second ring member, the first ring member being operatively connected to the ring mount for movement relative to the second ring member between a closed position and an opened position of said ring members, in the closed position the two ring members forming a substantially continuous, closed loop for allowing loose-leaf pages retained by the rings to be moved along the rings from one ring member to the other, and in the opened position the two ring members forming a discontinuous, open loop for adding or removing loose-leaf pages from the rings;
a page turning assist device more rigid than the loose leaf pages, the page turning assist device being adapted to be captured by the rings for movement along the rings from one ring member to another ring member for use in turning loose leaf pages retained by the rings; and
a holder mounted on the page turning assist device and adapted to releasably hold an object for movement with the page turning assist device.

2. The notebook as set forth in claim 1 wherein the holder is expandable for holding objects of various sizes.

3. The notebook as set forth in claim 2 wherein the holder is sized and shaped for holding a writing implement.

4. The notebook as set forth in claim 3 in combination with a writing implement.

5. The combination as set forth in claim 4 wherein the writing implement has a cross-sectional diameter between about 6.5 mm and about 16 mm.

6. The combination as set forth in claim 5 wherein the writing implement is selected from a group consisting of a pen and a pencil.

7. The notebook as set forth in claim 3 wherein the holder comprises an accordion folded member that is resiliently moveable between a more folded condition and an expanded, more unfolded condition.

8. The notebook as set forth in claim 7 wherein the holder further comprises a bracket mounted on the page turning assist device for securing the accordion folded member to the page turning assist device.

9. The notebook as set forth in claim 1 wherein the page turning assist device is generally rectangular in shape.

10. The notebook as set forth in claim 9 wherein the page turning assist device is formed from cardboard.

11. The notebook as set forth in claim 1 in combination with loose-leaf pages having a width, a length, and a thickness, the page turning assist device having a width less than the width of the loose-leaf pages.

12. The combination as set forth in claim 11 wherein the page turning assist device has a length less than the length of the loose-leaf pages.

13. The combination as set forth in claim 11 wherein the page turning assist device has a thickness greater than the thickness of the loose-leaf pages.

14. A page turning assist device for use in turning loose leaf pages retained on rings of a ring mechanism, the page turning assist device comprising a base having opposite side margins and being more rigid than the loose leaf pages, at least one aperture in one of the side margins of the base sized and shaped for receiving a corresponding one of the rings therethrough to permit the base to slide along the ring for use in turning the loose leaf pages on the ring mechanism, a holder mounted on the base for generally conjoint movement with the base on the ring, the holder being adapted for releasably securing an object to the base for movement with the base.

15. The page turning assist device as set forth in claim 14 wherein the holder is expandable for holding objects of various sizes.

16. The page turning assist device as set forth in claim 15 wherein the holder is sized and shaped for holding a writing implement.

17. The page turning assist device as set forth in claim 14 wherein the holder comprises an accordion folded member that is resiliently moveable between a more folded condition and an expanded, more unfolded condition.

18. The page turning assist device as set forth in claim 17 wherein the holder further comprises a bracket mounted on the page turning assist device for securing the accordion folded member to the page turning assist device.

19. The page turning assist device as set forth in claim 14 wherein the page turning assist device is generally rectangular in shape.
